(19) United States
(12) Patent Application Publication
(10) Pub. No.: US 2026/0205700 A1
(43) Pub. Date: Jul. 16, 2026

(54) TONE MAPPING CURVE ADJUSTING METHOD AND APPARATUS, EXPOSURE METHOD AND APPARATUS, COMPUTER DEVICE, READABLE STORAGE MEDIUM, AND PROGRAM PRODUCT

(71) Applicant: Glenfly Tech Co., Ltd., Shanghai (CN)

(72) Inventors: Jing YANG, Shanghai (CN); Xiaolong WU, Shanghai (CN)

(21) Appl. No.: 19/432,620

(22) Filed: Dec. 24, 2025

(30) Foreign Application Priority Data
Jan. 14, 2025 (CN) 202510058814.9

(51) Int. Cl. H04N 23/73; H04N 23/72; H04N 23/76

(52) U.S. Cl. CPC H04N 23/73; H04N 23/72; H04N 23/76

(57) ABSTRACT

Tone mapping curve adjusting method and apparatus, exposure method and apparatus, computer device, computer-readable storage medium, and computer program product are provided. The tone mapping curve adjusting method includes: determining a brightness range based on a cumulative histogram corresponding to a to-be-processed image, the brightness range including a first brightness endpoint value and a second brightness endpoint value; acquiring a reference brightness value in an exposure process for the to-be-processed image and a target brightness value obtained by adjusting the reference brightness value based on a histogram limiting condition; determining an adjustment point of a tone mapping curve based on the reference brightness value, the target brightness value, the first brightness endpoint value, and the second brightness endpoint value, the adjustment point including a point where the target brightness value is adjusted towards the reference brightness value; and adjusting the tone mapping curve based on the adjustment point.

### CROSS-REFERENCE TO RELATED APPLICATION

This application claims priority under 35 U.S.C. § 119 to Chinese Patent Application No. 202510058814.9, filed with CNIPA on Jan. 14, 2025, entitled “TONE MAPPING CURVE ADJUSTING METHOD AND APPARATUS, EXPOSURE METHOD AND APPARATUS, COMPUTER DEVICE, READABLE STORAGE MEDIUM, AND PROGRAM PRODUCT”, the entire contents of which are incorporated herein by reference.

### TECHNICAL FIELD

The present application relates to the field of image processing technologies, and in particular, to a tone mapping curve adjusting method, a tone mapping curve adjusting apparatus, an exposure method, an exposure apparatus, a computer device, a computer-readable storage medium, and a computer program product.

### BACKGROUND

One of core functions of an image system is image display, and a good display effect can reproduce an original scenario more truly. Tone mapping is an important component affecting a reproduction system. In nature, a tone mapping curve is a brightness mapping function, and an input brightness is mapped to an output brightness through the mapping function. The tone mapping curve has an effect of mapping a brightness of an input image to a narrower brightness range, thereby realizing dynamic range compression.

The tone mapping includes global tone mapping and local tone mapping. The local tone mapping requires partitioning and is complex. In the global tone mapping, a single tone mapping curve is adopted to increase values of low brightness pixels and decrease values of high brightness pixels of the whole image; however, a scenario with some dark regions may lose details under the condition of single global tone mapping.

### SUMMARY

In view of the above technical problems, it is necessary to provide tone mapping curve adjusting method and apparatus, exposure method and apparatus, a computer device, a computer-readable storage medium, and a computer program product, which can introduce information of automatic exposure to a tone mapping curve and improve accuracy of tone mapping curve adjustment.

In a first aspect, the present application provides a tone mapping curve adjusting method, the method including:
determining a brightness range based on a cumulative histogram corresponding to a to-be-processed image, the brightness range including a first brightness endpoint value and a second brightness endpoint value;
acquiring a reference brightness value in an exposure process for the to-be-processed image and a target brightness value obtained by adjusting the reference brightness value based on a histogram limiting condition;
determining an adjustment point of a tone mapping curve based on the reference brightness value, the target brightness value, the first brightness endpoint value, and the second brightness endpoint value, wherein the adjustment point includes a point where the target brightness value is adjusted towards the reference brightness value; and
adjusting the tone mapping curve based on the adjustment point.

In an embodiment, the method further includes:
acquiring an illumination scenario mode;
determining the adjustment point of the tone mapping curve based on the reference brightness value, the target brightness value, the first brightness endpoint value, and the second brightness endpoint value includes:
determining an adjustment logic based on the illumination scenario mode; and
processing the reference brightness value, the target brightness value, the first brightness endpoint value, and the second brightness endpoint value based on the adjustment logic to obtain the adjustment point of the tone mapping curve.

In an embodiment, processing the reference brightness value, the target brightness value, the first brightness endpoint value, and the second brightness endpoint value based on the adjustment logic to obtain the adjustment point of the tone mapping curve includes:

determining that adjustment points of the tone mapping curve include (0,0), (histₗ, levelₗ), (target_{final}, min(0.18, target_{ideal})), (histₕ, levelₙ), (1,1) in a case that the illumination scenario mode is a first illumination scenario mode and the target brightness value meets a brightness condition based on the first brightness endpoint value, where histₗ is the first brightness endpoint value, target_{final} is the target brightness value, target_{ideal} is the reference brightness value, histₕ is the second brightness endpoint value, levelₗ and levelₙ are preset constants, and min means solving of a minimum value; where for each point pair, a first value is an abscissa of an original point on the tone mapping curve, a second value is an abscissa of a reference point on the tone mapping curve, and an ordinate of the original point is adjusted to be equal to an ordinate of the reference point;
determining that adjustment points of the tone mapping curve include (0,0), (target_{final}, min(0.18, target_{ideal})), (histₕ, levelₕ), (1,1) in a case that the illumination scenario mode is the first illumination scenario mode and the target brightness value does not meet the brightness condition based on the first brightness endpoint value;
determining that adjustment points of the tone mapping curve include (0,0), (histₗ, levelₗ), (0.5*target_{final}, max(0.10, 0.5*target_{final})) (target final, max(target_{final}, 0.18)), (1.5*target_{final}, max(1.5*target_{final}, 0.28)), (histₕ, levelₕ), (1,1) in a case that the illumination scenario mode is a second illumination scenario mode, where max means solving of a maximum value;
where an illumination brightness corresponding to the first illumination scenario mode is greater than an illumination brightness corresponding to the second illumination scenario mode.

In a second aspect, the present application further provides an exposure method, the method including:
acquiring brightness values of respective blocks of a to-be-processed image, and calculating a weighted image average brightness corresponding to the to-be-processed image based on the brightness values of respective blocks;
obtaining a base brightness value based on the brightness values of respective blocks and exposure parameters;
determining an illumination scenario based on the brightness values of respective blocks;
obtaining a reference brightness value based on the base brightness value and the illumination scenario, and obtaining a target brightness value based on the weighted image average brightness and the reference brightness value;
obtaining a camera gain adjustment value based on the weighted image average brightness and the target brightness value; and
performing exposure based on the camera gain adjustment value.

In an embodiment, obtaining the base brightness value based on the brightness values of respective blocks and the exposure parameters includes:
calculating a global average brightness based on the brightness values of respective blocks;
obtaining a scenario illuminance based on the global average brightness and the exposure parameters of a camera; and
determining the base brightness value corresponding to the scenario illuminance.

In an embodiment, determining the illumination scenario based on the brightness values of respective blocks includes:
dividing the to-be-processed image into initial regions according to a preset dividing mode, and calculating a brightness average value of each initial region based on the brightness values of the blocks;
grouping the initial regions to obtain a foreground region and a background region, and obtaining a first average value difference between the background region and the foreground region based on the brightness average values of respective initial regions;
selecting a target region from the initial regions included in the background region, and calculating a second average value difference between the global average brightness and the target region;
obtaining a scenario parameter value based on the first average value difference and the second average value difference; and
determining that the illumination scenario is a light-facing scenario in a case that the scenario parameter value is less than or equal to a target value, and determining that the illumination scenario is a backlight scenario in a case that the scenario parameter value is greater than the target value.

In an embodiment, obtaining the reference brightness value based on the basic brightness value and the illumination scenario and obtaining the target brightness value based on the weighted image average brightness and the reference brightness value include:
acquiring global histogram statistical information corresponding to the to-be-processed image, and determining a cumulative histogram based on the global histogram statistical information;
determining average brightness values corresponding to pixels in respective preset ranges based on the cumulative histogram;
obtaining a first adjustment coefficient based on the scenario parameter value, obtaining a second adjustment coefficient based on the average brightness value corresponding to pixels in respective preset ranges and the global average brightness, and obtaining a third adjustment coefficient based on an average brightness value corresponding to pixels in a first target preset range and the global average brightness;
obtaining the reference brightness value based on the first adjustment coefficient, the second adjustment coefficient and the base brightness value in a case that the illumination scenario is the light-facing scenario;
obtaining the reference brightness value based on the first adjustment coefficient, the third adjustment coefficient and the base brightness value in a case that the illumination scenario is the backlight scenario; and
obtaining the target brightness value based on the reference brightness value, the weighted image average brightness and an average brightness value corresponding to pixels in a second target preset range.

In an embodiment, obtaining the target brightness value based on the reference brightness value, the weighted image average brightness and the average brightness value corresponding to the pixels in the second target preset range includes:
obtaining a pixel number limiting condition based on the average brightness value corresponding to the pixels in the second target preset range; and
obtaining the target brightness value based on the pixel number limiting condition, the weighted image average brightness and the reference brightness value.

In an embodiment, obtaining the camera gain adjustment value based on the weighted image average brightness and the target brightness value includes:
taking a ratio of the target brightness value to the weighted image average brightness as the camera gain adjustment value.

In a third aspect, the present application further provides a tone mapping curve adjusting apparatus, the apparatus including:
a brightness range determining module, configured to determine a brightness range based on a cumulative histogram corresponding to a to-be-processed image, the brightness range including a first brightness endpoint value and a second brightness endpoint value;
a target brightness value determining module, configured to acquire a reference brightness value in an exposure process for the to-be-processed image and a target brightness value obtained by adjusting the reference brightness value based on a histogram limiting condition;
an adjustment point determining module, configured to determine an adjustment point of a tone mapping curve based on the reference brightness value, the target brightness value, the first brightness endpoint value, and the second brightness endpoint value, wherein the adjustment point includes a point where the target brightness value is adjusted towards the reference brightness value; and
an adjusting module, configured to adjust the tone mapping curve based on the adjustment point.

In a fourth aspect, the present application further provides an exposure apparatus, the apparatus including:
a weighted image average brightness determining module, configured to acquire brightness values of respective blocks of a to-be-processed image, and calculate a weighted image average brightness corresponding to the to-be-processed image based on the brightness values of respective blocks;
a base brightness value determining module, configured to obtain a base brightness value based on the brightness values of respective blocks and exposure parameters;
an illumination scenario determining module, configured to determine an illumination scenario based on the brightness values of respective blocks;
a target brightness value generating module, configured to obtain a reference brightness value based on the base brightness value and the illumination scenario and obtain a target brightness value based on the weighted image average brightness and the reference brightness value;
a camera gain adjustment value determining module, configured to obtain a camera gain adjustment value based on the weighted image average brightness and the target brightness value; and
an exposure module, configured to perform exposure based on the camera gain adjustment value.

In a fifth aspect, the present application further provides a computer device, including a memory and a processor. The memory stores a computer program therein. The processor, when executing the computer program, performs the steps of the method according to any one of the above embodiments.

In a sixth aspect, the present application further provides a computer-readable storage medium, having a computer program stored thereon. The computer program, when executed by a processor, causes the processor to perform the steps of the method according to any one of the above embodiments.

In a seventh aspect, the present application further provides a computer program product, including a computer program. The computer program, when executed by a processor, causes the processor to perform the steps of the method according to any one of the above embodiments.

According to the tone mapping curve adjusting method and apparatus, the exposure method and apparatus, the computer device, the computer-readable storage medium and the computer program product, the brightness range is first determined, the reference brightness value in the exposure process for the to-be-processed image and the target brightness value obtained by adjusting the reference brightness value based on the histogram limiting condition are obtained, and the adjustment point of the tone mapping curve is then determined based on the reference brightness value and the target brightness value in the automatic exposure process, the first brightness endpoint value and the second brightness endpoint value, so that the information of automatic exposure can be introduced into the tone mapping curve, and the tone mapping curve adjustment is improved.

### BRIEF DESCRIPTION OF THE DRAWINGS

In order to illustrate the technical solutions in the embodiments of the present application more clearly, the drawings required for describing the embodiments of the present application are described briefly. Apparently, the following described drawings are merely for some embodiments of the present application, and other related drawings can be derived from these drawings by those of ordinary skill in the art without any creative effort.

FIG. 1 is a schematic flowchart of a tone mapping curve adjusting method according to an embodiment;

FIG. 2 is a schematic flow diagram of an adjustment point generating step in an embodiment;

FIG. 3 is a schematic diagram of a curve obtained after a tone mapping curve and a gamma2.2 curve are fused in an embodiment;

FIG. 4 illustrates a result of joint adjustment by AE, tone mapping, and gamma in a normal (first) illumination scenario mode in an embodiment;

FIG. 5 illustrates a result of joint adjustment by AE, tone mapping, and gamma in a low (second) illumination monitoring scenario mode in an embodiment;

FIG. 6 is a schematic flowchart of an exposure method according to an embodiment;

FIG. 7 is a schematic diagram of block-dividing of a to-be-processed image in an embodiment;

FIG. 8 is a schematic diagram of a preset region-dividing mode in an embodiment;

FIG. 9 is a flow diagram of an automatic exposure and tone mapping curve joint adjustment algorithm based on scenario illuminance information in an embodiment;

FIG. 10 is a structural block diagram of a tone mapping curve adjusting apparatus according to an embodiment;

FIG. 11 is a structural block diagram of an exposure apparatus according to an embodiment; and

FIG. 12 is an internal structure diagram of a computer device according to an embodiment.

### DETAILED DESCRIPTION

The present application is described in further detail below according to embodiments in conjunction with the accompanying drawings, to make the objectives, technical solutions, and advantages of the present application more clear. It should be understood that the specific embodiments described herein are only for explaining the present application, rather than limiting the present application.

A tone mapping curve adjusting method is provided according to an embodiment. In the embodiment, it is exemplarily illustrated that the method is applied to a terminal. It is to be understood that the method may alternatively be applied to a server, or applied to a system including a terminal and a server and is implemented through interaction between the terminal and the server. As shown in FIG. 1, the method includes the following steps S102 to S108.
S102 includes: determining a brightness range based on a cumulative histogram corresponding to a to-be-processed image, the brightness range including a first brightness endpoint value and a second brightness endpoint value.

The cumulative histogram corresponding to the to-be-processed image may be obtained based on a global histogram of the to-be-processed image. A statistical histogram takes grayscale values as the abscissa and a frequency of occurrence of each grayscale value as the ordinate. The cumulative histogram represents cumulative probability distribution of the grayscale of components of the to-be-processed image, and each probability represents a probability of grayscale values smaller than or equal to the grayscale value.

The brightness range is preset, and the first brightness endpoint value and the second brightness endpoint value may respectively be a low 1% image brightness and a high 95% image brightness in the cumulative histogram. Here, the low 1% image brightness refers to the brightness value in the abscissa corresponding to the ordinate taking the value of 1% in the cumulative histogram. Similarly, the high 95% refers to the brightness value in the abscissa corresponding to the ordinate taking the value of 95% in the cumulative histogram. In other embodiments, the first brightness endpoint value and the second brightness endpoint value may be set to other image brightness values as long as the second brightness endpoint value is larger than the first brightness endpoint value.
S104 includes: acquiring a reference brightness value in an exposure process for the to-be-processed image and a target brightness value obtained by adjusting the reference brightness value based on a histogram limiting condition.

In an Automatic Exposure (AE) algorithm, an ideal reference brightness value target_{ideal} for image adjustment is obtained according to illuminance information of a scenario. However, in most scenarios, overall exposure is limited by a histogram to limit numbers of overall over-bright and over-dark pixels; consequently, after a camera gain is adjusted using the AE algorithm, only the target brightness value target_{final} limited based on the histogram can be achieved rather than the ideal reference brightness value target_{ideal}.

A tone mapping module presets a fixed tone mapping curve, can map normalized high dynamic range image data to a low dynamic range, perform gamma correction, and finally output corresponding colors to a display. Therefore, the preset tone mapping curve is required to be fine-tuned by using the ideal reference brightness value target_{ideal} of an AE stage and the target brightness value target_{final} limited by the histogram.
S106 includes: determining an adjustment point of the tone mapping curve based on the reference brightness value, the target brightness value, the first brightness endpoint value, and the second brightness endpoint value. The adjustment point includes a point where the target brightness value is adjusted towards the reference brightness value.

In the present application, abscissas of two to-be-adjusted points may be determined based on the first and second brightness endpoint values. For example, the first and second brightness endpoint values are denoted as minLw and highLw respectively, and then, histₗ and histₕ are calculated from these two values. Specific formulas are as follows:

$${level}_{l} = 0 \text{.015}$$

$${hist}_{l} = max ( {level}_{l} , min ( {level}_{l} + 0.0076 ) )$$

$${level}_{h} = 0.95$$

$${hist}_{h} = min ( {level}_{h} , max ( {level}_{h} - 0.0305 ) )$$

here, histₗ and histₕ are the abscissas of the two corresponding to-be-adjusted points respectively, levelₗ and levelₙ are abscissas of target points corresponding to the two to-be-adjusted points, and in the present application, ordinates of the to-be-adjusted points are adjusted to be equal to ordinates of the target points.
S108 includes: adjusting the tone mapping curve based on the adjustment point.

The adjustment point is a point of the tone mapping curve where required to be adjusted, and includes the point where the target brightness value is adjusted towards the reference brightness value. Hence, the situation that pixels of a target brightness region are too bright or too dark due to limitation by the histogram can be compensated.

After the adjustment point is determined, the tone mapping curve is adjusted based on the adjustment point, thereby realizing adjustment on a tone of the to-be-processed image.

According to the tone mapping curve adjusting method, the brightness range is first determined, the reference brightness value in the exposure process of the to-be-processed image and the target brightness value obtained by adjusting the reference brightness value based on the histogram limiting condition are obtained, and the adjustment point of the tone mapping curve is then determined based on the reference brightness value and the target brightness value in the automatic exposure process, the first brightness endpoint value and the second brightness endpoint value. In this way, the information of automatic exposure can be introduced into the tone mapping curve, and the tone mapping curve adjustment is improved.

In an optional embodiment, the method further includes: acquiring an illumination scenario mode. Accordingly, determining the adjustment point of the tone mapping curve based on the reference brightness value, the target brightness value, the first brightness endpoint value, and the second brightness endpoint value includes: determining an adjustment logic based on the illumination scenario mode; and processing the reference brightness value, the target brightness value, the first brightness endpoint value, and the second brightness endpoint value based on the adjustment logic to obtain the adjustment point of the tone mapping curve.

The tone mapping module has two modes: a first illumination scenario mode and a second illumination scenario mode. An illumination brightness corresponding to the first illumination scenario mode is greater than an illumination brightness corresponding to the second illumination scenario mode. For example, the first illumination scenario mode is a normal illumination scenario mode, and the second illumination scenario mode is a low illumination monitoring scenario mode.

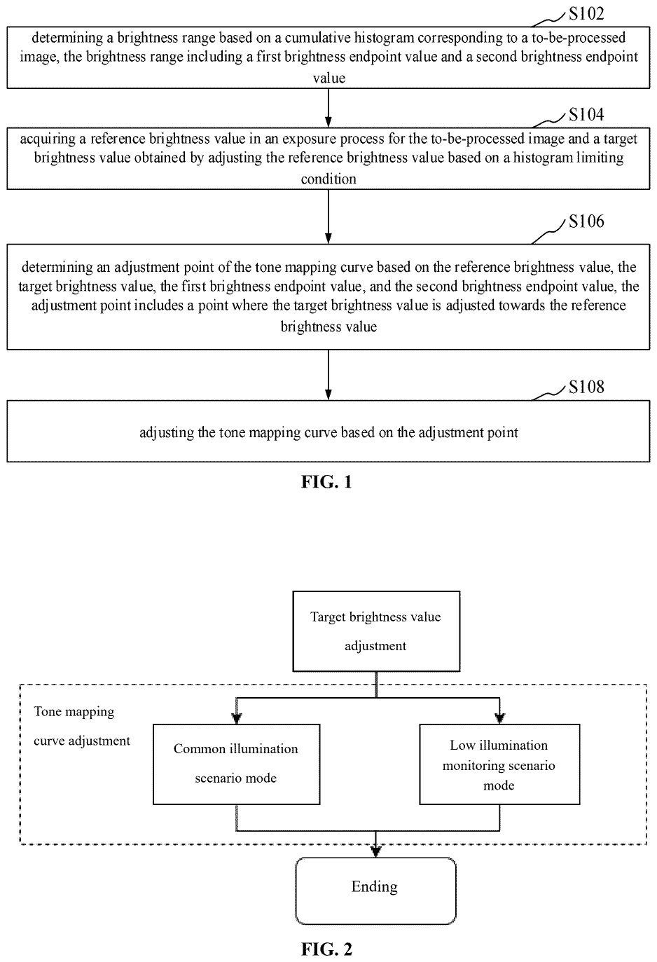

Different illumination scenario modes correspond to different adjustment points. In the present application, the adjustment point is generated through determination based on the illumination scenario mode and the corresponding adjustment logic. Specifically, as shown in FIG. 2, the target brightness value and the reference brightness value are obtained from the AE process, and then, the adjustment point corresponding to the tone mapping curve are determined based on the illumination scenario mode (the normal (first) illumination scenario mode and the low (second) illumination scenario mode), thereby adjusting the tone mapping curve. In this way, it is able to automatically adapt to different illumination scenario modes to improve the accuracy of the generation of the adjustment point.

In the above embodiment, a tone mapping curve adjustment solution for the normal illumination scenario mode and the low illumination monitoring scenario mode is provided, so that requirements of different scenarios can be better adapted.

In an optional embodiment, processing the reference brightness value, the target brightness value, the first brightness endpoint value, and the second brightness endpoint value based on the adjustment logic to obtain the adjustment point of the tone mapping curve includes: determining that adjustment points of the tone mapping curve include (0,0), (histₗ, levelₗ), (target_{final}, min(0.18, target_{ideal})), (histₕ, levelₕ), (1,1) in a case that the illumination scenario mode is a first illumination scenario mode and the target brightness value meets a brightness condition based on the first brightness endpoint value, where histₗ is the first brightness endpoint value, target_{final} is the target brightness value, target_{ideal} is the reference brightness value, histₕ is the second brightness endpoint value, levelₗ and levelₙ are preset constants, and min means solving of a minimum value; where for each point pair, a first value is an abscissa of an original point on the tone mapping curve, a second value is an abscissa of a reference point on the tone mapping curve, and an ordinate of the original point is adjusted to be equal to an ordinate of the reference point; and determining that adjustment points of the tone mapping curve include (0,0), (target_{final}, min(0.18, target_{ideal})), (histₕ, levelₙ), (1,1) in a case that the illumination scenario mode is the first illumination scenario mode and the target brightness value does not meet the brightness condition based on the first brightness endpoint value;
determining that adjustment points of the tone mapping curve include (0,0), (histₗ, levelₗ), (0.5*target_{final}, max(0.10, 0.5*target_{final})), (target_{final}, max(target_{final}, 0.18)), (1.5*target_{final}, max(1.5*target_{final}, 0.28)), (histₕ, levelₕ), (1,1) in a case that the illumination scenario mode is a second illumination scenario mode, where max means solving of a maximum value; where an illumination brightness corresponding to the first illumination scenario mode is greater than an illumination brightness corresponding to the second illumination scenario mode.

A boundary value for determining whether the brightness condition based on the first brightness endpoint value is meet may be histₗ+0.1. In other embodiments, the brightness condition may alternatively use other boundary values, which is not limited herein.

In the first illumination scenario mode, such as the common illumination scenario mode, following determinations are mainly performed in the present application.

If the target brightness value target_{final} is less than histₗ+0.1, adjustment points for the preset tone mapping curve are (0,0), (histₗ, levelₗ), (target_{final}, min(0.18, target_{ideal})), (histₕ, levelₙ) and (1,1). In each point pair, a first value is an abscissa of a point a on the original tone mapping curve, and a second value is an abscissa of a target point b for corresponding adjustment, and an ordinate value of the point a after adjustment is equal to an ordinate value of the point b, thereby achieving the effect of target curve smooth movement.

The adjustment point (target_{final}, min(0.18, target_{ideal})) is intended to adjust the target brightness value target_{final} towards the ideal reference brightness target_{ideal}, so the situation that pixels of a target brightness region are too bright or too dark due to limitation by the histogram can be compensated. Meanwhile, a limitation of 0.18 of the target point is added, so as to avoid that the image is excessively brightened to whiten the whole image.

If the target brightness value target_{final} is larger than histₗ+0.1, adjustment points for the preset tone mapping curve are (0,0), (target_{final}, min(0.18, target_{ideal})), (histₕ, levelₕ) and (1,1). The adjustment point (histₗ, levelₗ) is removed to prevent pixel value inversion during adjustment.

In the second illumination scenario mode, such as the low illumination monitoring scenario mode, a following determination is performed in the present application.

In the low illumination monitoring scenario, in order to clearly reflect details of a target region, adjustment points for adjusting the tone mapping curve here are as follows: (0,0), (histₗ, levelₗ), (0.5*target_{final}, max(0.10, 0.5*target_{final})), (target_{final}, max(target_{final}, 0.18)), (1.5*target_{final}, max(1.5*target_{final}, 0.28)), (hist), levelₕ) and (1,1). Pixel values near the target brightness value are stretched to a flat linear region of the tone mapping curve, thereby ensuring details near the target brightness region.

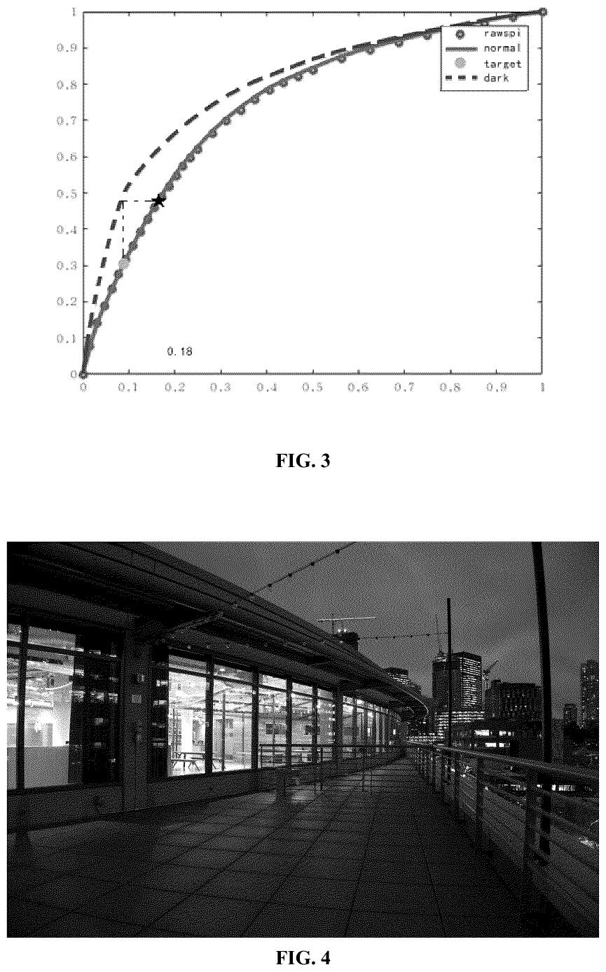

As shown in FIG. 3, in order to conveniently display a mapping relationship between pixels of a low brightness region, a curve obtained by fusing the tone mapping curve and a gamma2.2 curve is shown in FIG. 3. The hollow dots in FIG. 3 represent a preset fusion curve. The solid line represents a tone mapping and gamma2.2 fusion curve obtained by the present disclosure in the common illumination scenario mode, and the dashed line represents a tone mapping and gamma2.2 fusion curve obtained by the present disclosure in the low illumination monitoring scenario mode.

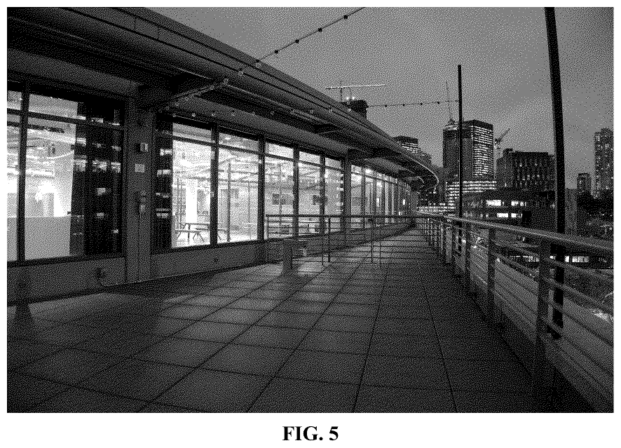

The filled dot represents target_{final} point. Here, for example, the target brightness value target_{final}=the reference brightness value target_{ideal}, and after AE and tone mapping joint adjustment, the curve in the normal illumination scenario mode is almost consistent with the preset curve. In the low illumination monitoring scenario mode, the ordinate value corresponding to target_{final} is equal to the ordinate value of the star icon (whose abscissa is 0.18) in FIG. 3. In the adjusted curve, the brightness value near a point of the target brightness value target_{final} is increased, and a pixel mapping range is increased, so that the details of a corresponding dark region of the image are clearer. As shown in FIG. 4 and FIG. 5, in the low illumination monitoring scenario mode, the dark region in FIG. 5 is more detailed.

In the above embodiment, the tone mapping curve adjustment solution for the normal illumination scenario mode and the low illumination monitoring scenario mode is provided, so that requirements of different scenarios can be better adapted.

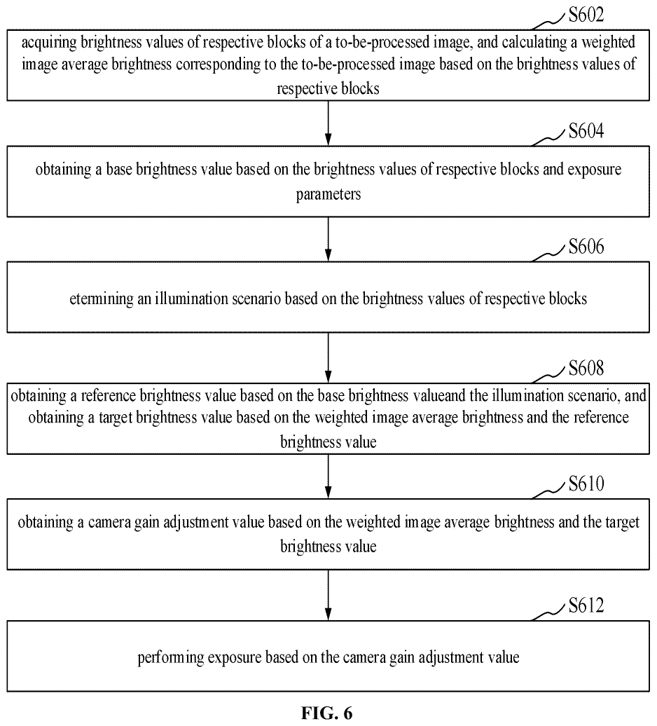

In an embodiment, an exposure method is provided. In the embodiment, it is exemplarily illustrated that the method is applied to a terminal. It is to be understood that the method may alternatively be applied to a server, or applied to a system including a terminal and a server and implemented through interaction between the terminal and the server. As shown in FIG. 6, the method in the embodiment includes the following steps S602 to S612.
S602 includes: acquiring brightness values of respective blocks of a to-be-processed image, and calculating a weighted image average brightness corresponding to the to-be-processed image based on the brightness values of respective blocks.

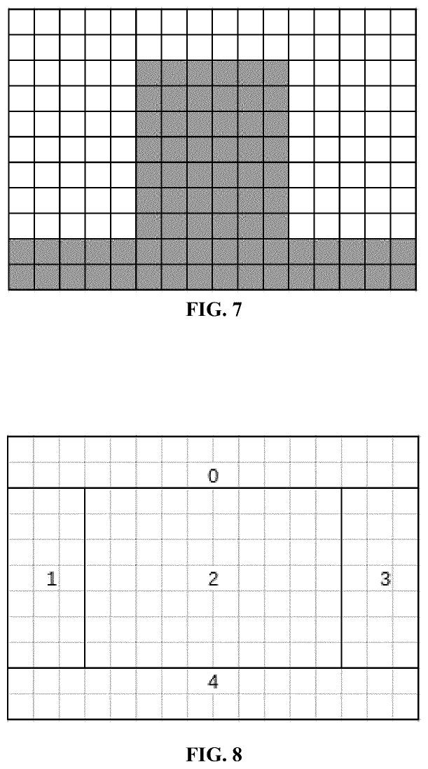

A shown in FIG. 7, the image is divided into N blocks. Here, the number of the blocks in FIG. 7 is only for reference, and the image can be divided into other numbers of blocks in other embodiments, which is not specifically limited herein. The brightness values of respective blocks can be obtained by a hardware statistic module.

The weighted image average brightness is a parameter for describing an overall brightness of the image, and takes into account weights of different brightness regions in the image, and the weighted image average brightness in the application can be calculated in the following way:

$${weighted}_{Y} = \frac{{\sum }_{i ∈ shaded \_ area} {w}_{i} {Y}_{i} + {\sum }_{j ∈ noshaded \_ area} {w}_{j} {Y}_{j}}{{\sum }_{i ∈ shaded \_ area} {w}_{i} + {\sum }_{j ∈ noshaded \_ area} {w}_{j}}$$

here, wᵢ and wⱼ represent weights of image blocks of a shaded area and a non-shaded area respectively. Yᵢ and Yⱼ represent average brightnesses (normalized to 0-1) of the image blocks of the shaded area and the non-shaded area respectively. The shaded area is located in the center of the image and has a high weight, and here, it is supposed that wᵢ=0.65 and wⱼ=0.35. In other embodiments, the weights may be set to other values.
S604 includes: obtaining a base brightness value based on the brightness values of respective blocks and exposure parameters.

The exposure parameters include an exposure duration, an ISO (a photosensitive speed of a CCD or CMOS photosensitive element), and an f-number.

In an optional embodiment, obtaining the base brightness value based on the brightness values of respective blocks and the exposure parameters includes: calculating a global average brightness based on the brightness values of respective blocks; obtaining a scenario illuminance based on the global average brightness and the exposure parameters of a camera; and determining the base brightness value corresponding to the scenario illuminance.

The global average brightness is an average value of brightnesses of all pixels in the to-be-processed image, and in the embodiment, for convenience of calculation, an average value of the brightnesses of respective blocks is calculated as the global average brightness.

The scenario illuminance Lux is calculated by using the exposure parameters of the camera and the global average brightness, and a specific calculation formula is as follows:

$$Lux = \frac{1}{Kc} \times \frac{{fs}^{2}}{ts} \times {global}_{mean} ,$$

where Kc is a camera constant and can be obtained by calibration, t is the exposure duration, s is the ISO, and fs is the f-number.

The base brightness value is obtained based on a mapping relationship between the scenario illuminance and the base brightness value, intermediate values are obtained by linear interpolation, and the specific mapping relationship can be the following mapping relationship table:

TABLE 1
mapping relationship between scenario illuminance
value and base brightness value

| log(lux) | target_{base} |
|---|---|
| log(30) | 0.0601 |
| log(125) | 0.1011 |
| log(300) | 0.1563 |
| log(700) | 0.18 |
| log(1000) | 0.2673 |
| log(7500) | 0.3586 |
| log(20000) | 0.4647 |

For example, when the scenario illuminance is 50, the intermediate value may be obtained by performing interpolation based on the base brightness value corresponding to the scenario illuminance of 30 and the base brightness value corresponding to the scenario illuminance of 125.
S606: determining an illumination scenario based on the brightness values of respective blocks.

The illumination scenario is obtained based on the brightnesses of all the blocks. Brightness average values of a foreground region and a background region can be calculated based on blocks included in the foreground region and the background region in the to-be-processed image, and then, the illumination scenario is determined based on the brightness average values of the foreground region and the background region.

In some optional embodiments, determining the illumination scenario based on the brightness values of respective blocks includes: dividing the to-be-processed image into initial regions according to a preset dividing mode, and calculating a brightness average value of each initial region based on the brightness values of the blocks; grouping the initial regions to obtain the foreground region and the background region, and obtaining a first average value difference between the background region and the foreground region based on the brightness average values of respective initial regions; selecting a target region from the initial regions included in the background region, and calculating a second average value difference between the global average brightness and the target region; obtaining a scenario parameter value based on the first average value difference and the second average value difference; and determining that the illumination scenario is a light-facing scenario in a case that the scenario parameter value is less than or equal to a target value, and determining that the illumination scenario is a backlight scenario in a case that the scenario parameter value is greater than the target value.

Specifically, as shown in FIG. 8, FIG. 8 is a schematic diagram of the preset dividing mode in an embodiment, the to-be-processed image is divided into initial regions according to the preset dividing mode. As shown in FIG. 8, the to-be-processed image is divided into 5 initial regions which are denoted as regions 0 to 4 respectively. The background region is composed of two parts: region 0, and a region with a larger average value in region 1 and region 3. The foreground region is composed of two parts: region 2, region 4, and a region with a smaller average value in region 1 and region 3. The average value difference between the background region and the foreground region is counted and recorded as p1. A difference between the global average brightness and an average value of region 2 is counted and recorded as p2. Finally, diff=p1−p2. In a case that the diff value is less than or equal to 0, the illumination scenario is regarded as the light-facing scenario, otherwise, the illumination scenario is regarded as the backlight scenario.
S608 includes: obtaining a reference brightness value based on the base brightness value and the illumination scenario, and obtaining a target brightness value based on the weighted image average brightness and the reference brightness value.

The reference brightness value is an optimal brightness value in the illumination scenario, the target brightness value is obtained by adjusting the reference brightness value to avoid too many overall over-bright or over-dark pixels, and the adjustment of the reference brightness value is obtained by limiting the number of the overall over-bright or over-dark pixels based on a cumulative histogram.

The reference brightness value is obtained based on the base brightness value, the illumination scenario, and the weighted image average brightness.

The reference brightness value and the target brightness value are utilized to determine an adjustment point during adjustment of a tone mapping curve. That is, the reference brightness value and the target brightness value are sent to a tone mapping curve adjusting module 1004, so as to facilitate the tone mapping curve adjusting module 1004 to determine the adjustment point based on the reference brightness value and the target brightness value.
S610 includes: obtaining a camera gain adjustment value based on the weighted image average brightness and the target brightness value.
S612 includes: performing exposure based on the camera gain adjustment value.

In an optional embodiment, obtaining the camera gain adjustment value based on the weighted image average brightness and the target brightness value includes: taking a ratio of the target brightness value to the weighted image average brightness as the camera gain adjustment value.

Specifically, the camera gain adjustment value delta is calculated by comparing the final brightness target value target_{final} and the weighted average brightness weighted_{Y} of the to-be-processed image:

$$delta = {target}_{f inal} / {weighted}_{Y}$$

Finally, according to the obtained camera gain adjustment value delta, automatic exposure adjustment of the camera is completed.

In the above embodiment, on the one hand, scenario illuminance information is introduced into an AE module, and light-facing scenario and backlight scenario determination is introduced, so that adaptability of the AE to different scenarios is improved. On the other hand, the reference brightness value and the target brightness value are sent to the tone mapping curve adjusting module 1004, so as to facilitate the tone mapping curve adjusting module 1004 to determine the adjustment point based on the reference brightness value and the target brightness value, thereby improving accuracy of tone mapping curve adjustment.

In an optional embodiment, obtaining the reference brightness value based on the base brightness value and the illumination scenario and obtaining the target brightness value based on the weighted image average brightness and the reference brightness value include: acquiring global histogram statistical information corresponding to the to-be-processed image, and determining a cumulative histogram based on the global histogram statistical information; determining average brightness values corresponding to pixels in respective preset ranges based on the cumulative histogram; obtaining a first adjustment coefficient based on the scenario parameter value, obtaining a second adjustment coefficient based on the average brightness values corresponding to pixels in respective preset ranges and the global average brightness, and obtaining a third adjustment coefficient based on an average brightness value corresponding to pixels in a first target preset range and the global average brightness; obtaining the reference brightness value based on the first adjustment coefficient, the second adjustment coefficient and the base brightness value in a case that the illumination scenario is the light-facing scenario; obtaining the reference brightness value based on the first adjustment coefficient, the third adjustment coefficient and the base brightness value in a case that the illumination scenario is the backlight scenario; and obtaining the target brightness value based on the reference brightness value, the weighted image average brightness and an average brightness value corresponding to pixels in a second target preset range.

The average brightness values corresponding to pixels in respective preset ranges may include: an average brightness of low 10% pixels recorded as low₁₀, an average brightness of low 10% to low 20% pixels recorded as low₁₀ₜₒ₂₀, an average brightness of high 20% pixels recorded as high₂₀, and an average brightness of high 2% pixels recorded as high₂. For the purposes of the following description, the average brightness of the high 20% pixels is taken as the average brightness value corresponding to the pixels in the first target preset range, and the average brightness of the high 2% pixels is taken as the average brightness value corresponding to the pixels in the second target preset range. In other embodiments, other values may be selected for pixels in each preset range, pixels in the first target preset range and pixels in the second target preset range, which are only exemplified here.

Obtaining the first adjustment coefficient based on the scenario parameter value may include:

$$gain = min ( max ( diff , - 1 ) , 1 )$$

where gain is the first adjustment coefficient, min means solving of a minimum value, and max means solving of a maximum value.

Obtaining the second adjustment coefficient based on the average brightness values corresponding to pixels in respective preset ranges and the global average brightness may include:
obtaining u₀ based on the average brightness of the low 10% pixels and the global average brightness:

$${u}_{0} = max ( ( \frac{1}{2.0} - \frac{{low}_{10}}{{global}_{mean} * 2.0} ) , 0. )$$

obtaining u₁ based on the average brightness of the low 10% to low 20% pixels and the global average brightness:

$${u}_{1} = max ( 1 - \frac{{low}_{10 to 20}}{{global}_{mean}} ) , 0. ) $$

obtaining weight based on the average brightness of the low 10% pixels and the average brightness of the low 10% to low 20% pixels:

$$weight = \frac{{low}_{10 to 20} - {low}_{10}}{{low}_{10 to 20}}$$

obtaining the second adjustment coefficient based on u₀, u₁ and weight:

$$u = weight * {u}_{1} + ( 1 - weight ) * {u}_{0}$$

Obtaining the third adjustment coefficient based on the average brightness value corresponding to the pixels in the first target preset range and the global average brightness includes:

$$w = min ( max ( \frac{{high}_{20}}{{global}_{mean} * 20} - \frac{1}{2.0} , 0. ) , 1. )$$

where w is the third adjustment coefficient.

Based on different illumination scenarios, the reference brightness value can be obtained based on the first adjustment coefficient, the third adjustment coefficient and the base brightness value, and specifically:
the reference brightness value is obtained based on the first adjustment coefficient, the second adjustment coefficient and the base brightness value in the case that the illumination scenario is the light-facing scenario:

$${target}_{i deal} = {target}_{b a s e} * ( 1 + gain * w )$$

the reference brightness value is obtained based on the first adjustment coefficient, the third adjustment coefficient and the base brightness value in the case that the illumination scenario is the backlight scenario:

$${target}_{i deal} = {target}_{base} * ( 1 + gain * u )$$

In an optional embodiment, obtaining the target brightness value based on the reference brightness value, the weighted image average brightness and the average brightness value corresponding to the pixels in the second target preset range includes: obtaining a pixel number limiting condition based on the average brightness value corresponding to the pixels in the second target preset range; and obtaining the target brightness value based on the pixel number limiting condition, the weighted image average brightness and the reference brightness value.

For most scenarios, the number of the overall over-bright and over-dark pixels is required to be limited, and here, a histogram is used for limitation. Firstly, the pixel number limiting condition is calculated using the cumulative histogram, the pixel number limiting condition includes an upper limit and a lower limit, and specifically:

$${delta}_{l o w} = \frac{0.5}{{high}_{2}} , {delta}_{high} = \frac{0.8}{{high}_{2}}$$

Then, the final target brightness value target_{final} is calculated from the upper limit delta_{high}, the lower limit delta_{low} and the weighted image average brightness weighted_{Y}:

$${target}_{f inal} = min ( max ( {target}_{ideal} , {delta}_{l o w} * {weighted}_{Y} ) , {delta}_{h i g h} * {weighted}_{Y} )$$

In the above embodiment, the scenario illuminance information is introduced into the AE module, and light-facing and backlight scenario determination is introduced, so that the adaptability of the AE to different scenarios is improved.

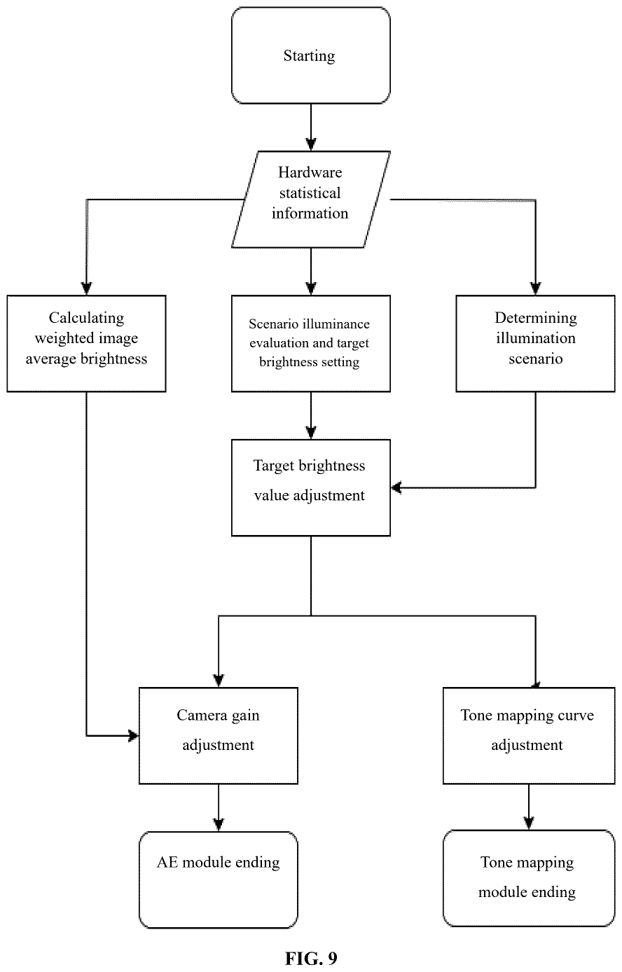

For convenience of understanding, as shown in FIG. 9, FIG. 9 is a flowchart of an automatic exposure and tone mapping curve joint adjustment algorithm based on the scenario illuminance information in an embodiment. Firstly, hardware statistical information is acquired, and the hardware statistical information may include the cumulative histogram corresponding to the to-be-processed image, the brightness values of respective blocks of the to-be-processed image, and the like

The processing procedure may include multiple threads or may be performed by a single thread. As shown in FIG. 9, one thread may calculate the weighted image average brightness of the to-be-processed image, reference may be made to the above description for a specific calculation manner. Another thread performs scenario illuminance evaluation and target brightness setting, the target brightness refers to the reference brightness value in the foregoing. A third thread performs illumination scenario determination, and then adjusts the reference brightness based on the illumination scenario to obtain the target brightness value. Subsequently, the camera gain is calculated based on the weighted image average brightness and the target brightness value, so that the AE module completes automatic exposure. Furthermore, the tone mapping curve can be adjusted based on the target brightness value and the reference brightness value, and adjustment of a tone mapping module is finished.

In the above embodiment, the tone mapping curve adjusting method based on the automatic exposure information can ensure that good display effect can be obtained in different scenarios.

It should be understood that, although the steps in the flowcharts involved in the above embodiments are shown in sequence as indicated by the arrows, the steps are not necessarily performed in sequence as indicated by the arrows. Unless explicitly stated herein, the steps are not limited to being performed in the exact order and may be performed in other orders. At least part of the steps in the flowcharts involved in the above embodiments may include multiple sub-steps or multiple stages, which are not necessarily performed at the same moment, but may be performed at different moments; and the sub-steps or the stages are not necessarily performed in sequence, but may be performed in turn or alternately with at least a part of other steps or of the sub-steps or the stages in other steps.

Based on the same inventive concept, embodiments of the present application further provide a tone mapping curve adjusting apparatus and an exposure apparatus for implementing the above tone mapping curve adjusting method and the above exposure method. The implementation solution for solving problems provided by each apparatus is similar to the implementation solution described in the above method, and therefore, for the specific definitions in one or more embodiments directed to the tone mapping curve adjusting apparatus and the exposure apparatus provided below, reference can be made to the definitions of the tone mapping curve adjusting method and the exposure method in the above description, and these definitions are not repeated herein.

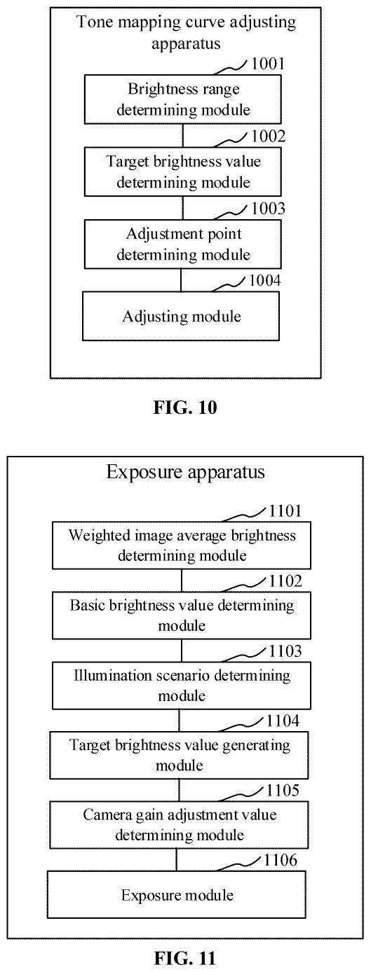

In an exemplary embodiment, as shown in FIG. 10, there is provided a tone mapping curve adjusting apparatus, including:
a brightness range determining module 1001, configured to determine a brightness range based on a cumulative histogram corresponding to a to-be-processed image, the brightness range including a first brightness endpoint value and a second brightness endpoint value;
a target brightness value determining module 1002, configured to acquire a reference brightness value in an exposure process for the to-be-processed image and a target brightness value obtained by adjusting the reference brightness value based on a histogram limiting condition;
an adjustment point determining module 1003, configured to determine an adjustment point of a tone mapping curve based on the reference brightness value, the target brightness value, the first brightness endpoint value, and the second brightness endpoint value, where the adjustment point includes a point where the target brightness value is adjusted towards the reference brightness value; and
an adjusting module 1004, configured to adjust the tone mapping curve based on the adjustment point.

In an optional embodiment, the adjustment point determining module 1003 is further configured to: acquire an illumination scenario mode; determine an adjustment logic based on the illumination scenario mode; and process the reference brightness value, the target brightness value, the first brightness endpoint value, and the second brightness endpoint value based on the adjustment logic to obtain the adjustment point of the tone mapping curve.

In an optional embodiment, the adjustment point determining module 1003 is further configured to: determine that adjustment points of the tone mapping curve include (0,0), (histₗ, levelₗ), (target_{final}, min(0.18, target_{ideal})), (histₕ, levelₙ) and (1,1) in a case that the illumination scenario mode is a first illumination scenario mode and the target brightness value meets a brightness condition based on the first brightness endpoint value, where histₗ is the first brightness endpoint value, target_{final} is the target brightness value, target_{ideal} is the reference brightness value, histₕ is the second brightness endpoint value, levelₗ and levelₙ are preset constants, and min means solving of a minimum value; where for each point pair, a first value is an abscissa of an original point on the tone mapping curve, a second value is an abscissa of a reference point on the tone mapping curve, and an ordinate of the original point is adjusted to an ordinate of the reference point; determine that adjustment points of the tone mapping curve include (0,0), (target_{final}, min(0.18, target_{ideal})), (histₕ, levelₕ) and (1,1) in a case that the illumination scenario mode is the first illumination scenario mode and the target brightness value does not meet the brightness condition based on the first brightness endpoint value; determine that adjustment points of the tone mapping curve include (0,0), (histₗ, levelₗ), (0.5*target_{final}, max(0.10, 0.5*target_{final})), (target_{final}, max(target_{final}, 0.18)), (1.5*target_{final}, max(1.5*target_{final}, 0.28)), (histₕ, levelₕ) and (1,1) in a case that the illumination scenario mode is a second illumination scenario mode, where max means solving of a maximum value; where an illumination brightness corresponding to the first illumination scenario mode is greater than an illumination brightness corresponding to the second illumination scenario mode.

In an exemplary embodiment, as shown in FIG. 11, there is provided an exposure apparatus, including:
a weighted image average brightness determining module 1101, configured to acquire brightness values of respective blocks of a to-be-processed image, and calculate a weighted image average brightness corresponding to the to-be-processed image based on the brightness values of respective blocks;
a base brightness value determining module 1102, configured to obtain a base brightness value based on the brightness values of respective blocks and exposure parameters;
an illumination scenario determining module 1103, configured to determine an illumination scenario based on the brightness values of respective blocks;
a target brightness value generating module 1104, configured to obtain a reference brightness value based on the base brightness value and the illumination scenario and obtain a target brightness value based on the weighted image average brightness and the reference brightness value;
a camera gain adjustment value determining module 1105, configured to obtain a camera gain adjustment value based on the weighted image average brightness and the target brightness value; and
an exposure module 1106, configured to perform exposure based on the camera gain adjustment value.

In an optional embodiment, the base brightness value determining module 1102 is specifically configured to: calculate a global average brightness based on the brightness values of respective blocks; obtain a scenario illuminance based on the global average brightness and the exposure parameters of a camera; and determine the base brightness value corresponding to the scenario illuminance.

In an optional embodiments, the illumination scenario determining module 1103 is specifically configured to: divide the to-be-processed image into initial regions according to a preset dividing mode, and calculate a brightness average value of each initial region based on the brightness values of the blocks; group the initial regions to obtain a foreground region and a background region, and obtain a first average value difference between the background region and the foreground region based on the brightness average values of respective initial regions; select a target region from the initial regions included in the background region, and calculate a second average value difference between the global average brightness and the target region; obtain a scenario parameter value based on the first average value difference and the second average value difference; and determine that the illumination scenario is a light-facing scenario in a case that the scenario parameter value is less than or equal to a target value, and determine that the illumination scenario is a backlight scenario in a case that the scenario parameter value is greater than the target value.

In an optional embodiment, the target brightness value generating module 1104 is specifically configured to: acquire global histogram statistical information corresponding to the to-be-processed image, and determine a cumulative histogram based on the global histogram statistical information; determine average brightness values corresponding to pixels in respective preset ranges based on the cumulative histogram; obtain a first adjustment coefficient based on the scenario parameter value, obtain a second adjustment coefficient based on the average brightness values corresponding to pixels in respective preset ranges and the global average brightness, and obtain a third adjustment coefficient based on an average brightness value corresponding to pixels in a first target preset range and the global average brightness; obtain the reference brightness value based on the first adjustment coefficient, the second adjustment coefficient and the base brightness value in a case that the illumination scenario is the light-facing scenario; obtain the reference brightness value based on the first adjustment coefficient, the third adjustment coefficient and the base brightness value in a case that the illumination scenario is the backlight scenario; and obtain the target brightness value based on the reference brightness value, the weighted image average brightness and an average brightness value corresponding to pixels in a second target preset range.

In an optional embodiment, the target brightness value generating module 1104 is specifically configured to: obtain a pixel number limiting condition based on the average brightness value corresponding to the pixels in the second target preset range; and obtain the target brightness value based on the pixel number limiting condition, the weighted image average brightness and the reference brightness value.

In an optional embodiment, the camera gain adjustment value determining module 1105 is specifically configured to take a ratio of the target brightness value to the weighted image average brightness as the camera gain adjustment value.

The modules in the tone mapping curve adjusting apparatus and the exposure apparatus may be wholly or partially implemented by software, hardware and a combination thereof. The modules may be embedded in, or independent from, a processor in a computer device in way of hardware, or may be stored in a memory in the computer device in way of software, such that the processor can conveniently call the modules to execute the operations corresponding to the modules.

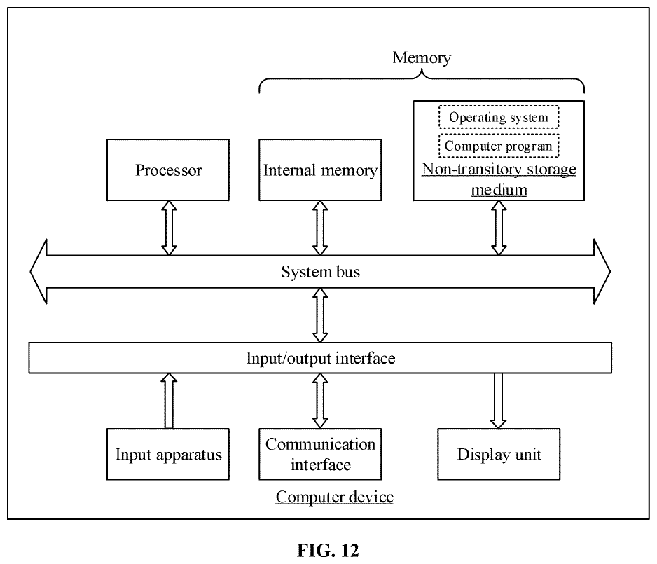

In an exemplary embodiment, there is provided a computer device, which may be a terminal, and an internal structure diagram of the computer device may be shown in FIG. 12. The computer device includes a processor, a memory, an input/output interface, a communication interface, a display unit, and an input unit. The processor, the memory, and the input/output interface are connected through a system bus, and the communication interface, the display unit, and the input unit are connected to the system bus through the input/output interface. The processor of the computer device is configured to provide computing and control capabilities. The memory of the computer device includes a non-transitory storage medium and an internal memory. The non-transitory storage medium stores an operating system and a computer program. The internal memory provides an environment for running of the operating system and the computer program in the non-transitory storage medium. The input/output interface of the computer device is configured to exchange information between the processor and an external device. The communication interface of the computer device is configured to be communicated with an external terminal in a wired or wireless mode, and the wireless mode can be implemented through WIFI, a mobile cellular network, near field communication (NFC), or other technologies. The computer program is executed by the processor to implement a tone mapping curve adjusting method and an exposure method. The display unit of the computer device is configured to generate a visually visible image and can be a display screen, a projection device, or a virtual reality imaging device. The display screen may be a liquid crystal display screen or an electronic ink display screen, and the input unit of the computer device may be a touch layer covering the display screen, or may be a key, a trackball or a touch pad arranged on a casing of the computer device, or may be an external keyboard, touch pad, mouse, or the like.

Those skilled in the art will appreciate that the structure shown in FIG. 12 is only a block diagram of a part of the structure associated with the application solution and does not constitute a limitation on the computer device to which the application solution is applied. A particular computer device may include more or fewer components than shown components, or certain components may be combined, or the components may have a different arrangement.

In an embodiment, there is further provided a computer device, including a memory and a processor. The memory stores a computer program therein, and the processor, when executing the computer program, performs the steps of the methods according to the foregoing embodiments.

In an embodiment, there is provided a computer-readable storage medium, having a computer program stored thereon. The computer program, when executed by a processor, causes the processor to perform the steps of the methods according to the foregoing embodiments.

In an embodiment, there is provided a computer program product, including a computer program. The computer program, when executed by a processor, causes the processor to perform the steps of the methods according to the foregoing embodiments.

It should be noted that user information (including but not limited to user apparatus information, user personal information, or the like) and data (including but not limited to data for analysis, stored data, displayed data, or the like) involved in the present application are information and data authorized by the user or sufficiently authorized by each party, and collection, use and processing of relevant data require compliance with relevant regulations.

It will be understood by those skilled in the art that all or part of the processes of the methods according to the embodiments described above may be implemented by a computer program instructing related hardware, and the computer program may be stored in a non-transitory computer-readable storage medium, and when executed, may include the processes of the embodiments of the methods described above. Any reference to memories, databases or other media used in the embodiments of the present application can include at least one of a non-transitory memory or a transitory memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, or the like. The transitory memory can include a random access memory (RAM), an external cache memory, or the like. By way of illustration and not limitation, the RAM can take many forms, such as a static random access memory (SRAM), a dynamic random access memory (DRAM), or the like. The databases involved in the embodiments of the present application may include at least one of relational database or non-relational database. The non-relational database may include, but is not limited to, a block chain-based distributed database, or the like. The processors referred to in the embodiments of the present application may include, but are not limited to, general processors, CPUs, GPUs, digital signal processors, programmable logic units, data processing logic units based on quantum calculations, artificial intelligence (AI) processors, or the like.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as falling within the scope of the present application.

The above-described embodiments are only several implementations of the present application, and the descriptions are relatively specific and detailed, but they should not be construed as limiting the scope of the present application. It should be understood by those of ordinary skill in the art that various modifications and improvements can be made without departing from the concept of the present application, and all fall within the protection scope of the present application. Therefore, the protection scope of the present application should be subject to the appended claims.

What is claimed is:

1. A tone mapping curve adjusting method, comprising:
determining a brightness range based on a cumulative histogram corresponding to a to-be-processed image, the brightness range comprising a first brightness endpoint value and a second brightness endpoint value;
acquiring a reference brightness value in an exposure process for the to-be-processed image and a target brightness value obtained by adjusting the reference brightness value based on a histogram limiting condition;
determining an adjustment point of a tone mapping curve based on the reference brightness value, the target brightness value, the first brightness endpoint value, and the second brightness endpoint value, wherein the adjustment point comprises a point where the target brightness value is adjusted towards the reference brightness value; and
adjusting the tone mapping curve based on the adjustment point.

2. The tone mapping curve adjusting method according to claim 1, further comprising:
acquiring an illumination scenario mode;
wherein determining the adjustment point of the tone mapping curve based on the reference brightness value, the target brightness value, the first brightness endpoint value, and the second brightness endpoint value comprises:
determining an adjustment logic based on the illumination scenario mode; and
processing the reference brightness value, the target brightness value, the first brightness endpoint value, and the second brightness endpoint value based on the adjustment logic to obtain the adjustment point of the tone mapping curve.

3. The tone mapping curve adjusting method according to claim 2, wherein processing the reference brightness value, the target brightness value, the first brightness endpoint value, and the second brightness endpoint value based on the adjustment logic to obtain the adjustment point of the tone mapping curve comprises:
determining that adjustment points of the tone mapping curve comprise (0,0), (histₗ, levelₗ), (target_{final}, min(0.18, target_{ideal})), (histₕ, levelₕ), (1,1) in a case that the illumination scenario mode is a first illumination scenario mode and the target brightness value meets a brightness condition based on the first brightness endpoint value, wherein hist is the first brightness endpoint value, target_{final} is the target brightness value, target_{ideal} is the reference brightness value, histₕ is the second brightness endpoint value, level and levelₙ are preset constants, and min means solving of a minimum value; wherein for each point pair, a first value is an abscissa of an original point on the tone mapping curve, a second value is an abscissa of a reference point on the tone mapping curve, and an ordinate of the original point is adjusted to be equal to an ordinate of the reference point;
determining that adjustment points of the tone mapping curve comprise (0,0), (target_{final}, min(0.18, target_{ideal})), (hist), levelₕ), (1,1) in a case that the illumination scenario mode is the first illumination scenario mode and the target brightness value does not meet the brightness condition based on the first brightness endpoint value;
determining that adjustment points of the tone mapping curve comprise (0,0), (hist), levelₗ), (0.5*target_{final}, max(0.10, 0.5*target_{final})) (target final, max(target_{final}, 0.18)), (1.5*target_{final}, max(1.5*target_{final}, 0.28)), (histₕ, levelₕ), (1,1) in a case that the illumination scenario mode is a second illumination scenario mode, where max means solving of a maximum value;
wherein an illumination brightness corresponding to the first illumination scenario mode is greater than an illumination brightness corresponding to the second illumination scenario mode.

4. An exposure method, comprising:
acquiring brightness values of respective blocks of a to-be-processed image, and calculating a weighted image average brightness corresponding to the to-be-processed image based on the brightness values of respective blocks;
obtaining a base brightness value based on the brightness values of respective blocks and exposure parameters;
determining an illumination scenario based on the brightness values of respective blocks;
obtaining a reference brightness value based on the base brightness value and the illumination scenario, and obtaining a target brightness value based on the weighted image average brightness and the reference brightness value;
obtaining a camera gain adjustment value based on the weighted image average brightness and the target brightness value; and
performing exposure based on the camera gain adjustment value.

5. The exposure method according to claim 4, wherein obtaining the base brightness value based on the brightness values of respective blocks and the exposure parameters comprises:
calculating a global average brightness based on the brightness values of respective blocks;
obtaining a scenario illuminance based on the global average brightness and the exposure parameters of a camera; and
determining the base brightness value corresponding to the scenario illuminance.

6. The exposure method according to claim 5, wherein determining the illumination scenario based on the brightness values of respective blocks comprises:
dividing the to-be-processed image into initial regions according to a preset dividing mode, and calculating a brightness average value of each initial region based on the brightness values of the blocks;
grouping the initial regions to obtain a foreground region and a background region, and obtaining a first average value difference between the background region and the foreground region based on the brightness average values of respective initial regions;
selecting a target region from the initial regions comprised in the background region, and calculating a second average value difference between the global average brightness and the target region;
obtaining a scenario parameter value based on the first average value difference and the second average value difference; and
determining that the illumination scenario is a light-facing scenario in a case that the scenario parameter value is less than or equal to a target value, and determining that the illumination scenario is a backlight scenario in a case that the scenario parameter value is greater than the target value.

7. The exposure method according to claim 6, wherein obtaining the reference brightness value based on the base brightness value and the illumination scenario and obtaining the target brightness value based on the weighted image average brightness and the reference brightness value comprise:
acquiring global histogram statistical information corresponding to the to-be-processed image, and determining a cumulative histogram based on the global histogram statistical information;
determining average brightness values corresponding to pixels in respective preset ranges based on the cumulative histogram;
obtaining a first adjustment coefficient based on the scenario parameter value, obtaining a second adjustment coefficient based on the average brightness values corresponding to pixels in respective preset ranges and the global average brightness, and obtaining a third adjustment coefficient based on an average brightness value corresponding to pixels in a first target preset range and the global average brightness;
obtaining the reference brightness value based on the first adjustment coefficient, the second adjustment coefficient and the base brightness value in a case that the illumination scenario is the light-facing scenario;
obtaining the reference brightness value based on the first adjustment coefficient, the third adjustment coefficient and the base brightness value in a case that the illumination scenario is the backlight scenario; and
obtaining the target brightness value based on the reference brightness value, the weighted image average brightness and an average brightness value corresponding to pixels in a second target preset range.

8. The exposure method according to claim 7, wherein obtaining the target brightness value based on the reference brightness value, the weighted image average brightness and the average brightness value corresponding to the pixels in the second target preset range comprises:
obtaining a pixel number limiting condition based on the average brightness value corresponding to the pixels in the second target preset range; and
obtaining the target brightness value based on the pixel number limiting condition, the weighted image average brightness and the reference brightness value.

9. The exposure method according to claim 8, wherein obtaining the camera gain adjustment value based on the weighted image average brightness and the target brightness value comprises:
taking a ratio of the target brightness value to the weighted image average brightness as the camera gain adjustment value.

10. A computer device, comprising a memory and a processor, the memory storing a computer program therein, wherein the processor, when executing the computer program, performs the steps of the tone mapping curve adjusting method according to claim 1.

11. A non-transitory computer-readable storage medium, having a computer program stored thereon, wherein the computer program, when executed by a processor, causes the processor to perform the steps of the tone mapping curve adjusting method according to claim 1.

12. A computer program product, comprising a computer program, wherein the computer program, when executed by a processor, causes the processor to perform the steps of the tone mapping curve adjusting method according to claim 1.

13. A computer device, comprising a memory and a processor, the memory storing a computer program therein, wherein the processor, when executing the computer program, performs the steps of the exposure method according to claim 4.

14. A non-transitory computer-readable storage medium, having a computer program stored thereon, wherein the computer program, when executed by a processor, causes the processor to perform the steps of the exposure method according to claim 4.

15. A computer program product, comprising a computer program, wherein the computer program, when executed by a processor, causes the processor to perform the steps of the exposure method according to claim 4.
